(19) United States
(12) Patent Application Publication
(10) Pub. No.: US 2012/0015081 A1
(43) Pub. Date: Jan. 19, 2012

(54) OXYGEN AND CARBON DIOXIDE ABSORPTION IN A SINGLE USE CONTAINER

(75) Inventors: John W. Crump, Buffalo, NY (US); Chieh-Chun Chau, Victor, NY (US); George E. Mckedy, Williamsville, NY (US); David S. Payne, West Seneca, NY (US); Thomas H. Powers, Mayville, NY (US); Stanislav E. Solovyov, Getzville, NY (US); Thomas J. Hurley, Kenmore, NY (US)

(73) Assignee: Multisorb Technologies, Inc., Buffalo, NY (US)

(21) Appl. No.: 12/984,230

(22) Filed: Jan. 4, 2011

Related U.S. Application Data
(63) Continuation-in-part of application No. 12/751,583, filed on Mar. 31, 2010.

(51) Int. Cl. B65D 81/26; A23F 3/00; A23F 5/00; A23L 3/00

(52) U.S. Cl. 426/124; 426/106

(57) ABSTRACT

The invention provides for an extended shelf life package comprising a material for mammal ingestion that degrades by oxidation, comprising an oxygen scavenger comprising a transition metal oxygen scavenger, a container substantially impervious to oxygen, wherein the container has a filter suspended in the container, the filter holds the material for mammal ingestion, and the container also holds the oxygen scavenger.

In another embodiment, the invention provides for an extended shelf life package comprising human ingestible material that degrades by giving off CO₂ comprising a carbon dioxide scavenger, a container substantially impervious to carbon dioxide, wherein the container has a filter suspended in the container, the filter holds the mammal ingestible material, and the container also holds the carbon dioxide scavenger.

### CROSS-REFERENCE TO RELATED APPLICATIONS

The present application is a continuation-in-part of pending U.S. patent application Ser. No. 12/751,583 filed Mar. 31, 2010, which is hereby expressly incorporated by reference.

### STATEMENT REGARDING FEDERALLY SPONSORED RESEARCH OR DEVELOPMENT

None.

### REFERENCE TO A “SEQUENCE LISTING”

Not applicable.

### BACKGROUND OF THE INVENTION

1. Field of the Invention

The invention primarily relates to the absorption of oxygen and/or carbon dioxide as well as regulation of relative humidity/water activity control in a food product in a storage container or package. In particular, it relates to the absorption of oxygen during storage of single use food containers, or carbon dioxide or a combination of oxygen and carbon dioxide scavenging.

2. Description of Related Art

In the packaging of foods, it is known that some food deteriorates by reacting with oxygen during the time it is stored. This has been treated by evacuation of packages to reduce and/or remove oxygen before sealing, providing wax coatings on food, and by lowering the temperature of storage. It is also known to utilize oxygen scavengers in the packaging of vegetable and animal based food material. There has been a particular interest in the preventing of oxidation of ground coffee as oxidation decreases the aroma and taste of the product. Coffee has been vacuum-packed or packed in nitrogen to remove as much oxygen as possible.

Certain foods also may emit CO₂ or other volatiles either through respiration or baking or roasting. Coffee in particular and roasted nuts produce a significant amount of carbon dioxide when roasted Coffee producers must then let coffee off-gas carbon dioxide prior to packaging or include a vent so that the package will not swell and/or burst. The time that is necessary to off-gas carbon dioxide also potentially allows flavor compounds to escape. Employing a carbon dioxide scavenger will allow coffee to be packaged soon after roasting without accumulation of carbon dioxide gas. This lack of staging/exposure for off-gassing will not only eliminate this economically negative processing time but will also consequently result in retaining co-offgassing compounds/volatiles that by their nature impart desirable characteristics of the organoleptic profile of the coffee product.

The unique and distinctive flavor of fresh roasted and brewed coffee is due primarily to compounds formed during roasting. W. Baltes et al, J. Agric. Food Chem. 35(3): 340-6 (1987); W. Baletes et al, Z. Lebensm. Unten. Forsch. 184(3): 179-86 (1987); W. Baltes et al, Z. Lebensm. Unters. Forsch. 184(6): 478-84 (1987); W. Baltes et al, Z. Lebensm. Unten. Forsch. 185(1): 5-9 (1987); W. Baltes et al, Z. Lebensm. Unters. Forsch. 184(6): 485-93 (1987); R. J. Clarke, Coffee, Vol. 2 Technology. Clarke and Macrae ed. 1987 Dept. Food Science, University of Reading. Reading; I. Flament and C. Chevallier. “Analysis of Volatile Constituents of Coffee Aroma.” Chern. Ind. (London): 1988; R. Tressl, “Formation of Components in Roasted Coffee.” Thermal Generation of Aromas. Parliment ed. 1989 American Chemical Society. Washington, D.C. As green coffee beans are roasted, amino acids, sugars, lipids and lignin in the bean degrade and react with each other to form thousands of mostly odorless compounds. Among these are a small subset of odor-active compounds. The chemical structures of some of these odors are known but most have yet to be described or at least the relative odor importance of the known components have yet to be demonstrated. What is generally accepted is that the aroma of coffee immediately after roasting is at its most desirable state. Within a few hours or days the amount of desirable aroma has decreased noticeably and many undesirable odors have become detectable. The chemistry of this flavor change may involve free radical reactions similar to those that formed the flavor during roasting. (See U.S. Pat. No. 5,087,469; col. 1, ll. 9-38).

Additionally, freshly ground roast coffee and nuts are quite aromatic and pleasantly so. Because these desirable flavor aromatics are volatile, any time lost between grinding and packaging diminishes flavor and consumer acceptance. Because CO₂ is also emitted immediately after roasting, processors must allow this to escape before packaging or risk puffing or ballooning and possible bursting of the package. A method of adsorbing CO₂ would allow freshly roasted coffee and other foods to be packaged immediately, saving manufacturing time and space, and delivering a product superior to any now available.

An approach for inhibition of oxidation, which has been attempted, is to use antioxidants during the process. For example, U.S. Pat. No. 5,384,143 describes a process in which the coffee extract is rapidly cooled to below 20° C. and then an antioxidant selected from erythorbic acid, ascorbic acid, and their water soluble salts, is added to the cooled extract. The extract is then filled into cans under oxygen free conditions. This technique is less expensive than carrying out the entire process under inert gas atmosphere but there are problems. In particular, coffee is a potent antioxidant which is able to scavenge oxygen faster than most antioxidants commonly used in foods. Therefore, although the antioxidants described in this patent remove some of the oxygen, they are not potent enough to prevent the coffee from scavenging a large portion of the oxygen present. Consequently, the coffee undergoes some oxidative damage. (See U.S. Pat. No. 6,093,436; col. 1, l. 54-col. 2, l. 2).

A further approach has been the use of enzyme systems. For example, the use of systems based upon glucose oxidase and alcohol oxidase have been suggested. However, these systems have not proved to be adequate since degradation due to oxygen still occurs. Also, these enzyme systems often produce hydrogen peroxide which is undesirable. (See U.S. Pat. No. 6,093,436; col. 2, ll. 3-8).

Therefore, it is an object of this invention to provide an antioxidant system which is relatively inexpensive and which is sufficiently potent to remove oxygen from beverage components, which are themselves antioxidants.

There is a need to provide an effective method of irreversibly absorbing CO₂ allowing the food to be packaged immediately after roasting, at its peak of flavor.

In particular, there is a need for improvement in storage techniques for single use ground coffee containers. The single use coffee containers are utilized in homes and offices and are not always subject to good inventory control and therefore may sit on shelves for a long period of time. Further, it is not economical to package single use containers in sophisticated, very low oxygen or nitrogen atmosphere. Typically single use coffee containers have about 3-5% oxygen by weight in the atmosphere of the container.

### BRIEF SUMMARY OF THE INVENTION

The invention provides for an extended shelf life package comprising a material for mammal ingestion that degrades by oxidation, comprising an oxygen scavenger comprising a transition metal oxygen scavenger, a container substantially impervious to oxygen, wherein the container has a filter suspended in the container, the filter holds the material for mammal ingestion, and the container also holds the oxygen scavenger.

In another embodiment, the invention provides for an extended shelf life package comprising mammal ingestible material that degrades by giving off CO₂ comprising a carbon dioxide scavenger, a container substantially impervious to carbon dioxide, wherein the container has a filter suspended in the container, the filter holds the mammal ingestible material, and the container also holds the carbon dioxide scavenger.

### BRIEF DESCRIPTION OF THE SEVERAL VIEWS OF THE DRAWING(S)

FIG. 1 and FIG. 2 are top and side views of a container for use in the invention.

FIG. 3 is a cross-section on line A-A of FIG. 2 of a prior art ready-to-brew coffee container.

FIG. 4 is an illustration of the invention utilizing a sachet containing oxygen scavenger or carbon dioxide scavenger, humidity regulator or a combination of scavengers and humidity regulators.

FIG. 5 is an illustration of the invention wherein a film having oxygen scavenger properties is attached to the lid of a ready-to-brew coffee container.

FIG. 6 is an illustration of the invention where a strip or bead of oxygen scavenger (or carbon dioxide scavenger, humidity regulator or a combination thereof) is placed at the bottom of the container.

FIG. 7 represents an oxygen scavenging behavior of iron-based oxygen scavenger films in the presence of coffee.

FIG. 8 represents an oxygen scavenging behavior of iron-based oxygen scavenging packet in the presence of coffee.

### DETAILED DESCRIPTION OF THE INVENTION

The invention has numerous advantages over prior practices in the art. The invention allows the formation of packaging systems where the active component effectively maintains the freshness of the food or medical product. The invention allows the formation of single serving ready-to brew-coffee containers with an extended shelf life, while not changing the function or design of the containers. Further, the containers of the invention are low in cost, and the sorbent containers of the invention further may utilize biodegradable materials for the oxygen scavenger and the container. The scavenger may be provided in a form that is particularly desirable for different food containers depending on their need for oxygen scavenging, carbon dioxide scavenging, and/or moisture absorbing. These and other embodiments of the invention will be apparent from the detailed description and drawings below.

The phrase “human ingestible material” is intended to include food, such as soup, coffee, and tea; and medical products that may be drank or ingested after being withdrawn from the filter cup of the invention. While water is the liquid normally used, other liquids compatible with humans, such as baby formula, fruit juice, ethyl alcohol and plasma, also could be used. The terms “sorbent,” “absorber,” and absorbent are used to indicate a material that scavenges (absorbs) oxygen, carbon dioxide, or water vapor. Humans are the preferred mammals, but drinks and medicines for animals also could be packaged for animals, such as dogs, cows, cats, and horses.

The formation of single serving ready-to-brew coffee that is stored in cups with lidding films is very successful. However, it is difficult to preserve the coffee aroma and coffee flavor when the cups are stored for an extended time on shelves. Ready to brew containers will be pierced at the top and bottom to allow water to enter and pass through the coffee grounds and filter, and then pass through the bottom of the cup after brewing. The deterioration of the coffee aroma and flavor is partially oxidative and partially evaporative. While the cups are normally packed in an inert environment, there remains an atmosphere of up to about 5% residual oxygen. Further reduction of the oxygen by flushing with nitrogen is not practical because of cost and the complexity of the package. The invention provides a cost-effective solution that does not require redesign of the ready-to-brew containers. Coffee machines are designed to accept cups of known design and it is not practical to change the design of the cup. Further, it is desirable that biodegradable materials be utilized as the cups are discarded after one use.

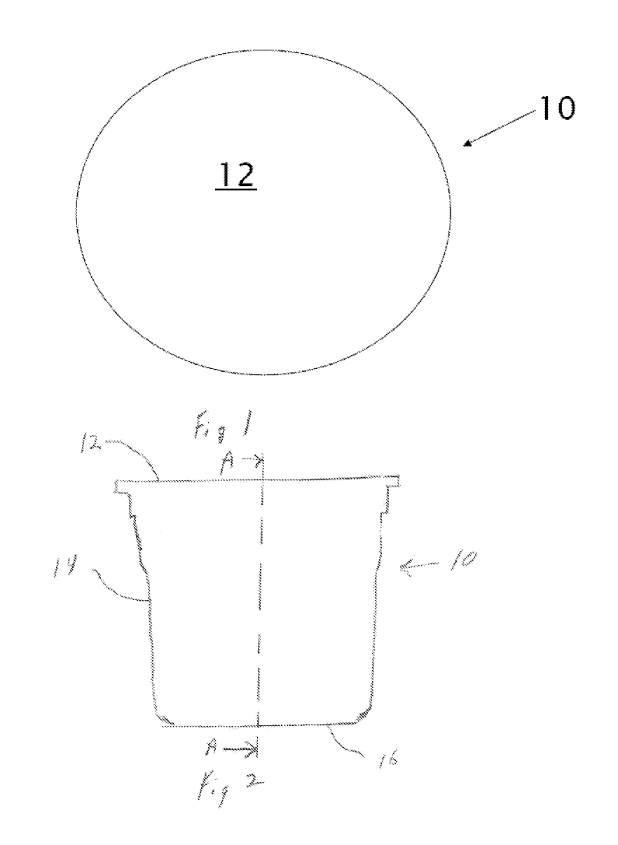

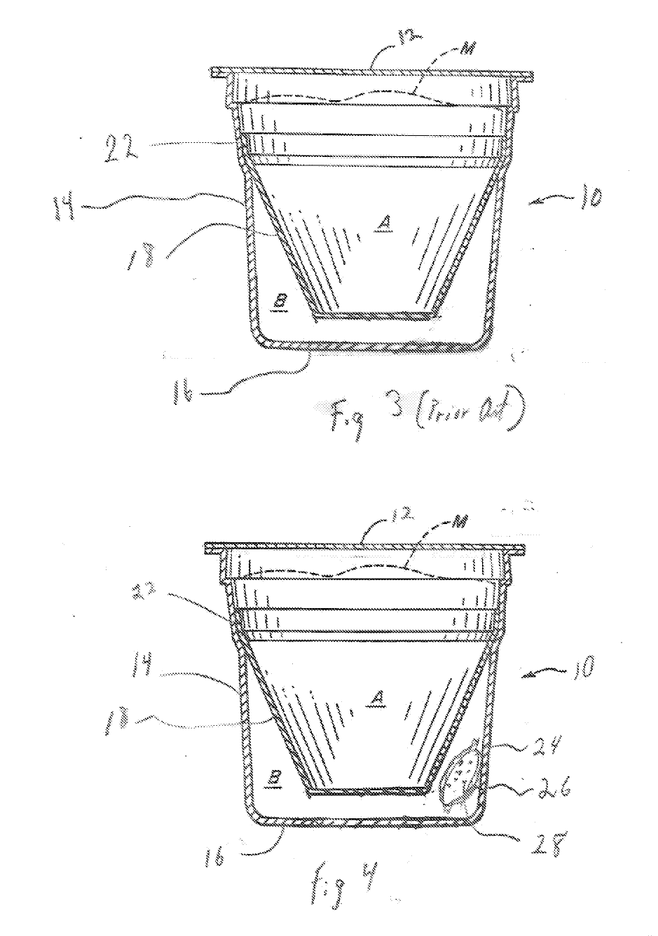

FIGS. 1 and 2 show a top and side view of a ready-to-brew coffee container 10. The container 10 has a lid 12 and exterior sides 14. During use, the lid 12 is pierced as is the bottom 16. Water is injected through the lid 12 and coffee is removed from the bottom 16. Cross-sectional line A-A is generally through the center of the container 10.

FIG. 3 is a cross-sectional view of a prior art ready-to-brew container 10. The container 10 has a filter 18 that is sealed at 22 to the side wall of the container 14. The coffee level in the containers is represented by M, and in use the lid 12 of the container is pierced by means not shown and hot water is injected into the container. The bottom of the container 16 is also pierced, by means not shown, and coffee is withdrawn from the bottom. The filter divides the cup into two spaces A and B. As stated above, this invention relates to improvements in the ready-to-brew coffee containers as well as other food and medicine containers. In the invention structures like portions as in the prior art cup are identically numbered as in FIG. 3.

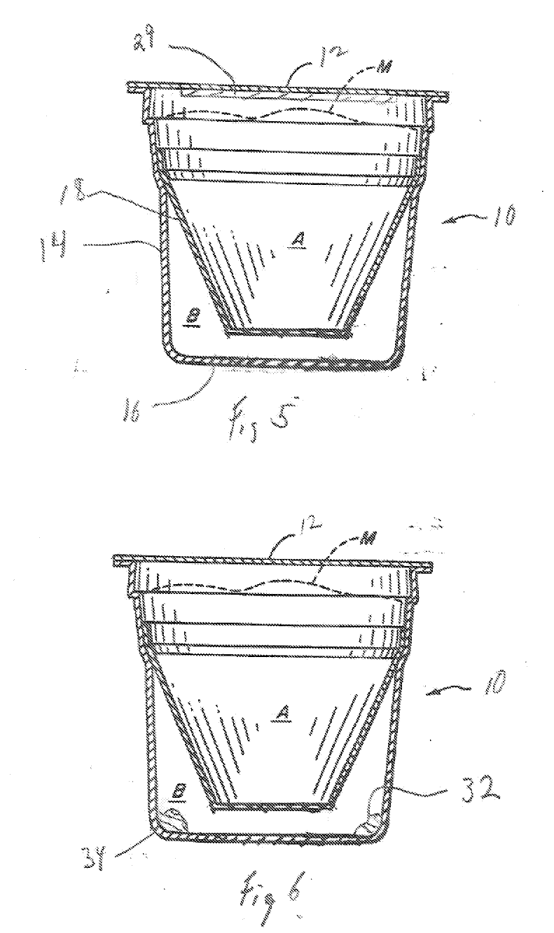

FIG. 4 illustrates the cross-section of an embodiment in the invention wherein a sachet 24 has been inserted in space “B”. This sachet 24 contains an oxygen absorber 28 such as iron in combination with salt and electrolyte. The materials in the sachet 24 will rapidly absorb oxygen during storage. The rapid absorbing of oxygen is beneficial as coffee also will absorb oxygen, but the oxygen scavenger in the sachet is at least ten times greater in rate of oxygen absorption than the coffee. The surface of the packet 26 is formed material that is vapor permeable but not water permeable. It maintains its integrity above the temperature of boiling water. The sachet 24 could be placed in either the A or B space of container 10.

Alternatively or additionally, the sachet may contain a CO₂ absorber capable of absorbing the CO₂ emitted from the coffee permitting it to be packaged a short time after roasting thereby minimizing loss of flavor through volatilization. It is also possible that a carbon dioxide absorbing sachet could be used in addition to the oxygen absorbing sachet.

Alternatively or additionally, the sachet may contain a moisture regulating formulation capable of maintaining the water activity of the coffee or other food product such as tea, at an optimum level so that it is not too dry or too moist which can affect the extractability of the flavor elements.

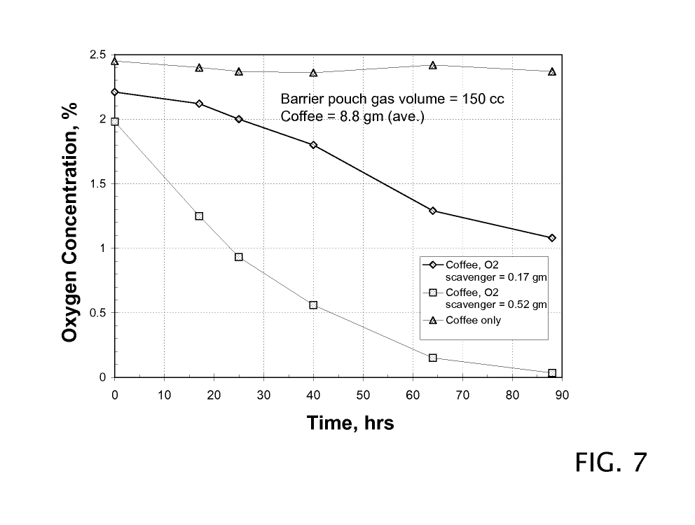

In the embodiment of FIG. 5, the ready-to-brew container has been provided with an oxygen absorbent film or other sorbent film 29 that is adhered to lid 12. The oxygen absorbent film would be adhered to the lid material 12 prior to the lid being placed on to the container. The film may be cast, laminated or extrusion coated onto the lid or preformed and attached to the lid by adhesives, ultrasonic sealing, or heat sealing. This embodiment has the advantage that oxygen absorbent is added to the lid prior to the packaging of the coffee. The oxygen absorbent film 29 may consist of multilayer structure in which the oxygen absorbent is in the inner layers of the structure. The film may be provided with an abrasion resistant layer or a slippery layer, not shown, that will provide abrasion resistance or slippage so that the coffee will not be able to remove the oxygen absorbent (scavenger) materials from the film. The resistance or slippage layer may be formed of polyethylene, polypropylene, polyamide and their copolymers. Conventional slip additives may be added into the layer that contacts the coffee to result in a coefficient of friction of 0.5 or below, preferably 0.3 or below. While described with reference to an oxygen absorbing film, it is possible that the film only contain CO₂ absorbing materials. It is further possible that it contain both carbon dioxide and oxygen absorbing materials.

In the embodiment of FIG. 6, the oxygen scavenger or other sorbent is placed on the bottom 16 and the bottom edge 34 of cup 10. The scavenger 32 may be placed there by a variety of techniques, but an extrusion technique, such is utilized for hot melt adhesive would be quick and could be done during manufacturing prior to the filter 18 being attached to the cup sides at 14. A preformed scavenger ring of oxygen or other sorbent film also could be attached to the bottom interior edge 34 of the cup. Placement of the sorbent also could be performed by other extrusion coating methods. The extrusion materials include hot melt polymers as well as plastisol materials that would cure in place.

It is possible to utilize material containers for coffee or other ingestible drinks that are quite permeable to oxygen and/or carbon dioxide. The containers are then sealed inside a bag that is impermeable to oxygen and carbon dioxide and water vapor. The bag has oxygen absorbers and/or carbon dioxide absorbers and/or water absorbers placed into the bag before it is sealed. The bag is opened immediately before use so that the ingestible drink such as ground coffee does not lose freshness before use. The permeable container may be formed of a biodegradable material, such as poly lactic acid (PLA) or a copolymer of PLA and another polymer such as polyethylene or an acrylic. Alternatively, the cups could be formed of a thin, low cost or very thin polymer, permeable to oxygen, carbon dioxide, and water vapor. The bag may be foil, polyvinyl alcohol, or high-density polyethylene, preferably in layers that allow the best barrier property to be achieved in the bag.

Any suitable resin may be utilized in the invention for the polymer that holds the oxygen scavenger or other sorbent. The polymer holds the sorbent so that it will not be carried into the coffee or other medical or food product when the container is used. Polymers useful for making the oxygen scavenging and absorbent articles can include common polyolefins such as low-density polyethylene (LDPE), high-density polyethylene (HDPE), polypropylene (PP), polystyrene (PS), high impact polystyrene (HIPS), polycarbonates (PC), poly(methyl methacrylate) (PMMA) and their derivatives or copolymers.

Polymers suitable for the invention and biodegradable include common polymers generated from renewable resources and biodegradable polymers such as polylactic acid copolymers, starch based polymers such as thermoplastics starch, polyhydroxyalkanoate (PHA), polyhydroxybutyrate (PHB). Biodegradable polymers that are petroleum based such as polyethylene oxide, polyvinyl alcohol (PVOH) are also included.

The invention uses common plastic article fabrication processes that include extrusion, injection molding, extrusion coating, lamination, tableting and compounding to form the sorbent structures including oxygen scavengers, CO₂ absorbers, and moisture regulators.

While the invention is discussed with respect to the utilization of a food container for ready-to-brew coffee. The concepts and container of the invention are also suitable for other uses. The containers disclosed would be suitable for use in other food products where water or other liquids are added to the material contained in the filter of the container and wherein a changed liquid is withdrawn after passing through the food product and the filter. Typical of such materials would be baby formula, tea, cocoa, milk components and soup broth. The containers also could be used for medical products that are shipped as a solid and then a carrier liquid is passed through the solid in the filter to result in a medicinal liquid. An example of this would be drugs such as powdered narcotics, such as morphine and methadone hydrochloride, and materials utilized as radiology tracers. The container also could be used to flavor alcoholic drinks.

The invention method of placing scavenger materials in a container also could be used for packaging of products that are sensitive to moisture. Such products include many medicines and food products. Such food products as flour, drink mixes, gelatin desserts, and salt or other seasonings are subject to deterioration if moisture is present in the container. The moisture absorbers may be used alone or in combination with oxygen absorbers. Moisture absorbers such as silica gel, molecular sieve, activated charcoal and clay may be used to regulate and absorb water vapor to prevent deterioration of the mammal ingestible materials. Moisture absorbent materials such as disclosed in U.S. Pat. No. 5,322,701—Cullen, herein incorporated by reference, could be placed into containers to enable longer storage of such materials.

The following are methods for making a solid oxygen absorbing composition or coating for the single use ready-to-brew coffee.

The oxygen scavenger may be in the form of a powder blend or a pressed solid formed from compressed particles and binder. A method of making a compressed or pressed oxygen absorbing disc, tablet or capsule is as follows. Forming a blend of powdered absorbent based on iron powder with sodium chloride as an electrolyte and silica gel as a moisture carrier and a binder that does not need to be heated very high in temperature. The binder can be a fine powdered polyethylene that will soften when under a pressure of between 3,000-50,000 pounds per square inch. The composition can also be heated to set or cure the binder but it cannot be heated above the boiling point of water to keep the moisture in the carrier. A suitable composition by weight would be about 18% polyethylene, 40% iron powder, 30% silica gel, 8% water and 2% sodium chloride. It is best to use a resin binder with a softening point above the boiling temperature of water.

A method for making an oxygen absorbing compound would be to put the oxygen absorbing composition in a thermoplastic material so that the oxygen absorbing compound could be filled into a container as a liquid ring and allowed to set or harden. This composition would be by weight about 40% thermoplastic resin, 30% iron powder, 20% silica gel, 9% water and 1% sodium chloride. An additive, such as CaCO₃, clay, or talc, could be used to increase the porosity of the resin and to increase the rate of oxygen absorption. This composition could be deposited into a container or made into a tape that could be put onto the inner sides of the container. The thermoplastic resin can be a vinyl acetate, ethyl vinyl acetate, polyurethane or combinations thereof.

Another method for making an oxygen absorbing composition is dispersing the oxygen absorbing composition into a polyvinylchloride plastisol. These plastisols are used as cap liners and as gaskets in caps and jar lids. This oxygen absorbing plastisol composition could then be put into the cup as a liner, a ring or coating along the sides of the cup. This composition would be semi liquid and could be filled into the cup and allowed to set. The plastisol may be selected from high-density polyethylene, high density polypropylene, acrylic vinyl acetate ethylene copolymer, ethylene vinyl acetate, vinyl acetate homopolymer, acetate ethylene copolymer, plasticized vinyl chloride, oxidized polyethylene homopolymer and polyurethane. The preferred plastisol is polyvinyl chloride as it does not react with foods and is resistant to the temperature of boiling water. The oxygen absorption composition can be up to 75% by weight with the other 25% being the polymer. One composition was 10.35 grams of polyvinylchloride plastisol, 12.51 grams of iron powder containing 2% by weight sodium chloride.

Illustrative of a plastisol material is polyvinyl plastisol in an amount of 10.35 grams was blended with 12.51 grams of 200 mesh iron powder containing 2% by weight sodium chloride. The blending was done with an electric high-speed mixer. A sample of the resulting composition was coated onto a container cap. The rate of oxygen absorption was measured over time.

| | Sample 1 | Sample 2 | Sample 3 | Sample 4 |
|---|---|---|---|---|
| Composition | 1.47 grams | 1.71 grams | 1.51 grams | 1.56 grams |
| weight | | | | |
| CC of oxygen | 10. | 10. | 10. | 10. |
| absorbed after | | | | |
| 22 hours | | | | |
| CC of oxygen | 15. | 14. | 15. | 15. |
| absorbed after | | | | |
| 46 hours | | | | |
| CC of oxygen | 24. | 22. | 24. | 23. |
| absorbed after | | | | |
| 96 hours | | | | |
| CC of oxygen | 37. | 32. | 37. | 35. |
| absorbed after | | | | |
| 184 hours | | | | |
| CC of oxygen | 37. | 32. | 37. | 35. |
| absorbed after | | | | |
| 234 hours | | | | |
| CC of oxygen | 51. | 41. | 48. | 47. |
| absorbed after | | | | |
| 330 hours | | | | |

The test vessel contained 500 cc of air or 100 cc of oxygen. The test was conducted at room temperature with a moisture source in the test vessel.

Another invention composition would be to disperse the sorbent composition in a multiple component carrier such as an emulsion, dispersion, suspension or other mixtures. By dispersing the sorbent in such a multi component system the resulting composition can be more easily applied to a cup as an oxygen scavenger or sorbent coating. These types of coatings can contain more of the oxygen absorbing composition and have greater permeability for oxygen. By not fully drying the water based systems we can have a self activation and self reacting oxygen absorbing coating. Glucose oxidase can be used in place of the iron. A xanthan gum emulsion, alginate emulsion or microcrystalline cellulose system can also be used. This system can also contain water to activate an iron based oxygen absorbing system. Adhesive based emulsion can also be used such as acrylic polymer emulsions in water, a polyvinyl acetate in water emulsion, and a vinyl acetate ethylene copolymer in water emulsion can be used. The oxygen absorbing composition would be an iron powder with sodium chloride as an electrolyte and a moisture carrier. The moisture carrier can be silica gel, hydrogel or any other moisture carrier that can hold moisture. It is also possible to not fully dry the moisture out of the emulsion thereby leaving some moisture in the coating to activate the oxygen absorber if iron powder is used. An alginate gel would be by weight percent 2.25% sodium alginate, 1.0% polysorbate 80, 0.2% sodium propionate and 96.55% distilled water. A xanthan gum emulsion would be by weight 2.0% xanthan gum, 43% isopropyl alcohol and 55% water. These two emulsions could be combined 1 part emulsion with 1 part oxygen absorbing composition composed of 99% iron powder and 1% sodium chloride as the electrolyte. The oxygen absorbing composition can be a fine iron as fine as 2-5 microns in particle size to improve the clarity of the oxygen absorbing coating or oxygen absorbing compound. A thin film layer or coating can be put over the final coating to insure that no oxygen absorbing ingredients or sorbents migrate out over time. This thin film cover can a cellulose acetate polymer, vinyl acetate ethylene copolymer, vinyl acetate homopolymer, acetate ethylene copolymer, plasticized vinyl chloride polymer, acrylic polymer or an oxidized polyethylene homopolymer.

Any suitable transition metal, typically including zinc, copper, iron, cobalt and zirconia, may be utilized in the oxygen scavenger of the invention. The preferred oxygen scavenger of reduced iron powder preferably has 1-200 um mean particle size, more preferably 5-50 um mean and most preferably 10-40 um mean. The iron can be mixed with salt or a combination of different electrolytic and acidifying components. The iron particles can, in a preferred embodiment, also be coated with electrolyte salt. The combination and relative fraction of activating electrolytic and acidifying components coated onto the iron particles can be selected according to the teachings of U.S. Pat. No. 6,899,822 and co-assigned published U.S. Patent Applications 2005/0205841 and 2007/020456, incorporated herein by reference. The coating technique is preferably a dry coating process as described in the references above.

The salt can be any salt such as sodium, potassium or calcium based ionic compounds that are soluble in water. Typical examples include NaCl, KCl, Na₂HPO₄ and others. A mixture of separate electrolytic and acidifying salt components can be advantageously used in the formulation as described in prior art. Sodium chloride is preferred because it is effective and low in cost.

The oxygen scavenging fabricated article may contain moisture regulators based upon silica gel, molecular sieve, activated carbon, clay or other minerals. The compounds may contain various levels of water to achieve water activities ranging from 0.01 to 0.85.

The film/tape/ribbons used in the invention may be a single or multilayer films that are porous or solid, and consisting of iron-based oxygen scavengers and electrolytes, such as disclosed in co-assigned U.S. patent application Ser. No. 12/416,685, filed Apr. 1, 2009, hereby incorporated by reference. The film optionally consists of moisture regulators with a chosen water activity. The film may be in circular or strips that can be fitted into a coffee cup or as a bent strip. Multilayer film is preferred with oxygen scavenger embedded inside the film and not exposed on film surface. Films with some porosity or voids are preferred to facilitate the rate of oxygen absorption. Moisture regulator can be incorporated into the film during extrusion or from post-extrusion processing. The films can be laminated to the lids or container sides.

The insert may be a ring shaped oxygen scavenging article with a ring diameter smaller than a coffee cup such that the insert can be laid flat inside the cup. The insert can be fabricated by die-cut from the films above or by other fabrication means such as injection molding and compression molding.

In the embodiment using strands/paste, a section of elongated or shaped oxygen scavenging material that consists of oxygen scavenger, salt and moisture regulators may be utilized. A method of making such a strand is by melt extrusion. The polymer is polyethylene, wax, polyethylene glycol, cellulosic polymers, polylactic acid, and starch-based copolymers. The moisture regulator is salts, silica gel, clay, molecular sieve or like that contains certain levels of moisture.

A method to remove CO₂ in coffee package is described as follows: using a scavenger specifically designed for CO₂ absorption. A packet made of a gas permeable polyolefin film containing carbon dioxide absorbing particulates is packaged with coffee beans and/or freshly ground coffee beans to absorb the off-gasses. The preferred packet will have high gas permeation and low water vapor permeation properties. The absorber will be capable of absorbing a high concentration of CO₂ and not interfere with the aromatics components of the coffee beans. The CO₂ absorber can contain certain amount of calcium hydroxide, silica gel and water, with other ingredients. Optionally calcium hydroxide may be replaced with other hydroxides such as sodium hydroxide and potassium hydroxide or mixtures of these and other hydroxides. Optionally, alkaline, alkaline earth or metal oxides may be used in conjunction with or replacing hydroxides. The oxides include but not limited to calcium oxide, aluminum oxide and magnesium oxide. These oxides may be used in mixture format. For reference, the range and formulations useful as CO₂ absorber are described in U.S. Pat. No. 5,322,701 assigned to Multiform Desiccants, Inc., hereby incorporated by reference.

The evolution of carbon dioxide can be tracked after freshly roasted coffee was packaged in a porous film sealed inside a non-porous package. The carbon dioxide absorption property can be measured by using MOCON PacCheck Model 650 Head Space Analyzer. The CO₂ absorber may be used in combination with an oxygen absorber such as that in Example 5.

As described for the oxygen absorbing materials above the oxygen and carbon dioxide scavenging formulations may be packaged in a format other than a packet. The carbon dioxide scavenging formulations may be enclosed in oxygen or carbon dioxide permeable capsule or a tablet that may be coated with a permeable or semi-permeable polymer material. Any resin or polymer permeable to oxygen and/or carbon dioxide may be used to coat the tablets. Water base polymer coating of the tablets is preferred. Preferred coating polymers are hydroxyl propylmethyl-cellulose or acrylic water base coatings. They may also be fabricated in a compact form, such as a disc or platelet, wrapped with a coating or polymer film that is gas permeable or semi-permeable. The coating method of making the disc, platelet or tablet can include dip coating, spray coating, flash coating, spin coating or any other known methods that are applicable to forming the product. The film method can include overcoating, lamination, multilayer lay up followed by die-cutting, and any other known methods that can make film composite layered articles. The methods of forming oxygen absorbents above may be used for forming sorbent materials for CO₂ absorbents.

The following examples are used to illustrate some parts of the invention. The Examples are illustrative and not exhaustive of the embodiments of the invention. Parts and percentages are by weight unless otherwise indicated.

### Example 1

### Oxygen Scavenging Films Packaged with Coffee

An extruded film that contained oxygen scavenger formulations was prepared by following a method described in co-assigned U.S. patent application Ser. No. 12/416,685, filed Apr. 1, 2009, hereby incorporated by reference, to test the oxygen scavenging behavior with the presence of coffee. The film was extruded from a mixture of 17/3/80 weight ratio of iron, sodium chloride and low density polyethylene from a film extrusion process. The materials were pre-mixed in a container and fed into a twin screw extruder with the extruder and die temperatures set at 220° C. Films, approximately 9 mil thick, were extruded from a 6″ die and collected on a spool. The 9 mil film samples, cut in approximately 1″ square pieces, were moisturized by placing drops of water on the surface of the film and blotted to remove dripping water. The films were placed in 7″×7″ plastic barrier bags with a package of approximately 8.8 gm ground coffee sealed in Tyvek breathable film bag. The barrier bag was hot sealed and injected with 150 cc O₂/N₂ mixture to reach an initial oxygen concentration of 3% or lower. The oxygen scavenging rate was measured by using MOCON PacCheck Model 450 Head Space Analyzer.

### Example 1A

### Coffee without Oxygen Scavenger

As a control, a separate barrier bag that consists of approximately 8.8 gm ground coffee removed from a container, conditioned in ambient temperature and environment for more than one hour, was sealed in Tyvek breathable film bag without scavenger, and was tested for oxygen concentration change over the same time period.

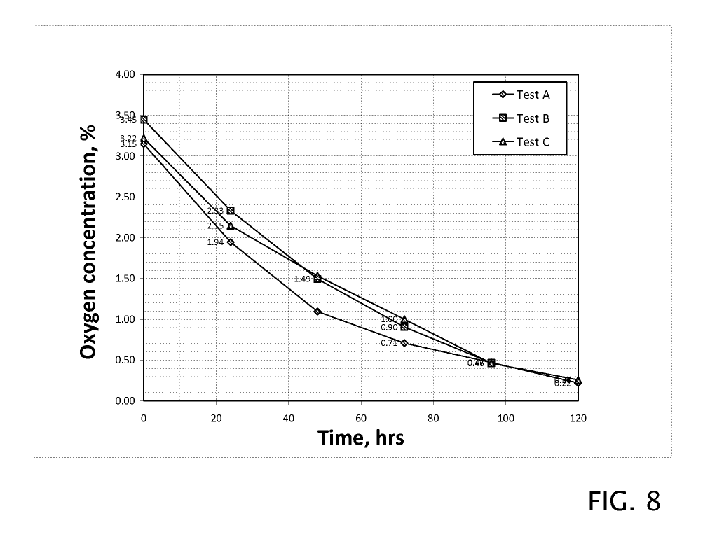

FIG. 7 shows the results of oxygen concentration change with time for two different scavenger loadings. The oxygen scavenging rate increases with the net amount of the scavengers used. In 88 hrs, a sample with a starting O₂ of 1.98% dropped to 0.04% with 0.52 gm of the scavenger in the film. A sample of 2.21% O₂ dropped to 1.08% with 0.17 gm of the scavenger in the film. The O₂ concentration of a sample with coffee packet only without scavenger dropped from 2.45% to 2.37% with some variation over the same time period. This example demonstrated that the scavenger gives much higher oxygen absorption rate than the combination of coffee and the background materials. The oxygen scavenging capability can be adjusted by the amount of the scavenger used and the preparation method adopted.

### Example 2

### Oxygen Scavenging Film Laminated on Coffee Lidding

Oxygen scavenging film was extruded with a mixture of 5.1/0.9/94 weight ratio of iron/NaCl/PLA in which PLA was NatureWorks PLA 2002D resin. The iron is the same as in Example 1. The composition of poly(lactic acid) resin (PLA) was pre-dried in a desiccant oven at 60° C. for at least 4 hrs before extrusion. The mixture was extruded in a twin screw extruder to make 4″ wide and 4 mil thick films. A coffee lidding foil film peeled from a Green Mountain 55 cc cup coffee was used for lamination test. Dow Chemical Integral™ 801 adhesive film was used as an adhesive for lamination test. The extruded Fe/PLA film was stacked with the Integral film and the lidding film to form Fe/PLA-adhesive-lidding sandwich structure. The structure was heat pressed in a heat sealer to form an oxygen-scavenging lidding structure.

### Example 3

### Oxygen Scavenging Sachet Packaged with Coffee

Packets with an approximate size of 1″×0.5″ made of a polyolefin film containing iron-based oxygen scavenging formulation and moisture regulator were used for the test. The packets contained iron-based scavenger and a moisture retaining material patented by Multisorb Technologies. The packet consists by weight of approximately 40% iron, 10% NaCl, 50% silica gel and some moisture. The packets had a water activity in the range of 0.4-0.8. The packets were stored with coffee in 150 cc barrier bag and tested as described in Example 1. The oxygen absorption property was measured by using MOCON PacCheck Model 450 Head Space Analyzer. FIG. 8 shows the oxygen scavenging result that demonstrated that the oxygen concentration decreased rapidly with time. The scavenging rate is much faster than the oxygen absorption rate of the coffee and the background material as shown in Example 1.

### Example 4

### Oxygen Scavenging Acrylic Coating Preparation

An acrylic emulsion was made using Neocryl A-5117 from Zeneca Resins. A formulation comprising 50 weight percent of this acrylic emulsion and 50 weight percent of a 200 mesh electrolytic iron reduced iron containing 2 weight percent sodium chloride was coated on eight square inches of a polypropylene substrate and dried with heat. The coat weight was 0.0135 grams per square inch. This oxygen absorbing coating was then placed inside of a test vessel with 500 cc of air or 100 cc of oxygen along with 2 square inches of a moisture saturated blotter paper. Three samples were tested.

| | Sample 1 | Sample 2 | Sample 3 |
|---|---|---|---|
| Composition weight | 1.47 grams | 1.71 grams | 1.51 grams |
| CC of oxygen absorbed after | 13. | 16. | 15. |
| 48 hours | | | |
| CC of oxygen absorbed after | 13. | 18. | 15. |
| 114 hours | | | |

### Example 5

### Oxygen Scavenging Polyvinyl Acetate Coating Preparation

A polyvinyl acetate in water emulsion was made using Vinac XX-210 from Air Products. Forty three weight percent of this polyvinyl emulsion was combined with 57 weight percent iron blend containing 200 mesh electrolytic reduced iron powder containing 2 weight percent of sodium chloride. This formulation was then coated on to eight square inches of a polypropylene substrate with a coat weight of 0.026 grams per square inch. The resulting coating was then placed inside of a test vessel with 500 cc of air or 100 cc of oxygen. A moisture source was also placed inside of the test vessel along with the sample. Three samples were tested.

| | Sample 1 | Sample 2 | Sample 3 |
|---|---|---|---|
| Composition weight | 1.47 grams | 1.71 grams | 1.51 grams |
| CC of oxygen absorbed after | 22. | 22. | 22. |
| 48 hours | | | |
| CC of oxygen absorbed after | 25. | 25. | 25. |
| 114 hours | | | |

### Example 6

### Extruded Carbon Dioxide Scavenging Sheets

VitaCal-H calcium hydroxide (Ca(OH)₂) powder was obtained from Mississippi Lime Company. The as received powder was mixed with ground silica gel (SG) powder that had a mean particle size of approximately 6 micron with a by weight mixture ratio of VitaCal-H/SG=75/25. The mixture was then blended with Petrothene GA502024 low density polyethylene resin obtained from LynodellBasell Industries to achieve the following blend weight ratios: Ca(OH)₂/SG/LDPE=30/10/60 and 40/10/50.

The blends were extruded in a single screw extruder with a flat sheet die attached to the extruder to make sheet materials. SAFOAM FPN3-40 obtained from Reedy International Co. was added in some runs to make samples that contained some voids or porosity. The extruder was set at 160-220° C. temperature range and the die was at 220° C. The extruded sheets, approximately 30-40 mil thick, were air cooled and winded on a roll.

Samples, approximately 0.4-0.7 grams were cut from the extruded sheets and used for carbon dioxide scavenging test. The samples were pre-hydrated with water to obtain approximately 1 to 5% water content determined by weight gain. The samples were then sealed in foil pouches filled with 600 cc gas that contained approximately 25-20% carbon dioxide balanced with nitrogen. The concentration of carbon dioxide was measured using a MOCON model 333 Pac-Check analyzer for various periods of time. The scavenging test data in terms of cc of CO2 absorbed is shown in Table-1. The formulations listed are weight ratios of Ca(OH)₂/SG/LDPE. Safoam was added as additional percentage. The data showed that carbon dioxide was absorbed effectively with the increase of time from 24-72 hrs.

TABLE 1
CO₂ absorption of extruded sheets

| | Formu- | Safoam+, | Weight, | 0 hrs | 24 hrs | 48 hrs | 72 hrs |
|---|---|---|---|---|---|---|---|
| ID | lation* | %** | gm | CO₂ absorbed, cc | | | |
| 1 | 30/10/60 | 5 | 0.69 | 0 | 6.82 | 12.7 | 17.2 |
| 2 | 30/10/60 | 2 | 0.66 | 0 | 6.94 | 12.8 | 20.1 |
| 3 | 40/10/50 | 0 | 0.57 | 0 | 7.7 | 12.9 | 20.6 |
| 4 | 40/10/50 | 5 | 0.48 | 0 | 9.96 | 11.2 | 17.8 |

*Formulation ratio = Ca(OH)₂/SG/LDPE by weight
**Percent by weight of formulation
+ safoam FPN 3-40 at hydrofluocarbon

### Example 7

### Injection Molded Carbon Dioxide Scavenging Discs

Ca(OH)₂ and silica gel used were the same as that of Example 7. Solka-floc wood fiber was obtained from International Fiber Company. Polypropylene was Sunoco CP360H resin, an elastomer Kraton G1657 was obtained from Kraton Polymers. These materials were blended to form the following material weight ratios: Ca(OH)₂/SG/Solka-floc/PP/Kraton 1657=48/6/6/36/4.

The materials were compounded in a twin screw compounding machine at 200-250 C temperature and extruded into strands, cooled in water and pelletized. The compounded pellets were injection molded in a single shot injection molding machine to form 1.3″ diameter discs. The discs were tested for carbon dioxide scavenging performance following the procedure described above. The test data showed that the discs gradually absorbed carbon dioxide with the test time. The absorbing rate was found increased when the disc surfaces were roughened with a sand paper prior to hydration. Table-2 shows the data of an injection molded disc, sanded and hydrated with 1% water prior to test.

TABLE 2
CO₂ absorption of injection molded discs

| | Disc | | | | | |
|---|---|---|---|---|---|---|
| | weight, | % | 0 hrs | 96 hrs | 120 hrs | 144 hrs |
| ID | gm | hydration | CO₂ absorbed, cc | | | |
| Sanded disc | 1.2 | 1.0 | 0 | 25.7 | 27.5 | 29.9 |

### Example 8

### Coated Carbon Dioxide Scavenging Paperboard

Coating formulations were prepared by using the same sorbent ingredients as described above. Luvitec K30 (BASF) polyvinylpyrrolidone (PVP) and polyethylene glycol 6000 (Aldrich Chemical) were used to make the coating solutions. PVP was dissolved in water to form a 17 wt % solution. PEG was dissolved in water to form a 48 wt % solution. Both solutions were clear and without residues. A mixture of the PEG and PVP solutions was made with 90/10 ratio to achieve a resin content of approximately 45% in water. The solutions were used to mix with Ca(OH)₂ and SG to form a coating solution that has the following coating formulation: Ca(OH)₂/SG/(PEG/PVP)=40/10/50.

The solutions were coated on an 20 mil paperboard substrate and dried in oven at 115° C. for more than 2 hours to remove the water. The coated samples were cut and hydrated with wet sponge to be used for carbon dioxide scavenging test by using the same test method described above. The test data is shown in Table-3. It is seen that carbon dioxide was absorbed rapidly over the test time period.

TABLE 3
CO₂ absorption of Ca(OH)₂-coated paperboard
coupons

| | Coating weight, | % | 0 hrs | 24 hrs | 96 hrs |
|---|---|---|---|---|---|
| ID | gm | hydration | CO₂ absorbed, cc | | |
| 100710-1 | 1.21 | 1.2 | 0 | 4.8 | 27.1 |
| 100710-2 | 1.44 | 4.0 | 0 | 15.8 | 50.5 |

Another coating solution was prepared by dissolving hydroxypropylcellulose resin (Hercules Klucel EF) in water to form a uniform solution. Ca(OH)₂ and SG were mixed with the solution to form a paste formulation approximately Ca(OH)₂/SG/Klucel=70/10/20 weight ratios. Klucel served as a binder for the solid formulation. The paste formulation was pressed on the same paperboard and dried to form a porous coating. The pressed-coating, although brittle, maintained integrity for test. It was hydrated with wet sponge and the weight gain was recorded. This high solid loading sample was tested for CO₂ scavenging performance. The data in Table-4 showed that CO₂ was absorbed rapidly over the test time period with high absorption capacity.

TABLE 4
CO₂ absorption of Ca(OH)₂-coated paperboard with
high solid loading

| | Coating weight, | % | 0 hrs | 24 hrs | 336 hrs |
|---|---|---|---|---|---|
| ID | gm | hydration | CO₂ absorbed, cc | | |
| 093010-1 | 0.52 | 5 | 0 | 67.3 | 86.8 |

### Example 9

### Capsule Filled with Carbon Dioxide Absorber Blend

Plastic capsules were hand filled with Multisorb Technologies CO₂ absorbing formula (semi-dry flow able granules) to achieve a CO₂ free environment. The capsules are breathable, semi-rigid, and are partially resistant to hot water. The device (capsule) provides for a timed absorption of CO₂ from coffee filled pods stored at various temperatures. The CO₂ capsule limits the expansion of a non-breathable cup (from CO₂ emissions from coffee) and also enhances or maintains the aromas and oils of the freshly roasted coffee powders and granules. The formulation enclosed in the capsules were Ca(OH)₂/SG=67/33 ratio with the silica gel containing water. The net formulation was Ca(OH)₂/SG/H2O=67/20/13 weight ratio. The blend was in loose powder format contained in the capsule. The CO₂ scavenging data is shown in Table-5.

TABLE 5
CO₂ absorption of Ca(OH)₂ filled capsule

| | Coating | % | 0 hrs | 72 hrs | 240 hrs |
|---|---|---|---|---|---|
| ID | weight, gm | hydration | CO₂ absorbed, cc | | |
| Caplug | 0.65 | 30 | 0 | 32.6 | 36.4 |

### Example 10

### Tablets Made of CO₂ Scavengers

The formulation used in Example 10 was compressed into tablets in a mold on a conventional cold or hot pressing machine. The tablets were then coated with polyethylene powders on the surface. The coated tablets were heated in a heating chamber at a temperature below the melting point of polyethylene but hot enough to fuse the coated powder particles. The coated tablets were conditioned at room temperature in 80% relative humidity environment for 16 hrs. The tablets showed CO₂ scavenging properties as listed in Table-6.

TABLE 6
CO₂ absorption of Ca(OH)₂ filled tablets

| | Coating | | | | | |
|---|---|---|---|---|---|---|
| | weight, | % | 0 hrs | 24 hrs | 48 hrs | 72 hrs |
| ID | gm | hydration | CO₂ absorbed, cc | | | |
| 5%-S2 | 0.85 | 5 | 0 | 11.3 | 14.9 | 17.3 |

### Example 11

### Sintered Structure Carbon Dioxide Scavenging Disc/Component

Ca(OH)₂ and silica gel used were the same as that of Example 7. Solka-floc wood fiber was obtained from International Fiber Company. Polypropylene was Sunoco CP360H resin, an elastomer Kraton G1657 was obtained from Kraton Polymers. These materials were blended to form the following material weight ratios: Ca(OH)₂/SG/Solka-floc/PP/Kraton 1657=48/6/6/36/4

The materials were compounded in a twin screw compounding machine at 200-250 C temperature, cooled in water and pelletized. The pellets will then be ground to relatively small particle size which will then expose portions of the active ingredients. This exposure will increase the adsorption rate. The ground active material is then fused together under heat and pressure which is applied to the material in a mold. The results are a porous sintered structure that increased active surface area.

The materials of the above Examples 1-10 are suitable for use in the container of this invention.

1. An extended shelf life package comprising a material for mammal ingestion that degrades by oxidation, comprising an oxygen scavenger comprising a transition metal oxygen scavenger, a container substantially impervious to oxygen, wherein the container has a filter suspended in the container, the filter holds the material for mammal ingestion, and the container also holds the oxygen scavenger.

2. The package of claim 1, wherein is the container further encloses a carbon dioxide absorbent.

3. The package of claim 2, wherein the carbon dioxide absorbent produces water when absorbing carbon dioxide.

4. The package of claim 1, wherein the transition metal is elemental iron and the oxygen scavenger is water activated.

5. The package of claim 1, wherein the food product is selected from the group consisting of coffee, tea, cocoa, and milk products.

6. The package of claim 1, wherein the food product is coffee and the scavenger absorbs oxygen at a rate of at least 10 times the oxygen absorption rate of the coffee.

7. The package of claim 6, wherein the rate of absorption of oxygen by the scavenger is at least 50 times that of the food product.

8. The package of claim 1, wherein the oxygen scavenger comprises activator and iron.

9. The package of claim 8, wherein the activator comprises a salt.

10. The package of claim 9, wherein the salt comprises sodium chloride.

11. The package of claim 1, wherein the filter holds ground coffee, tea or cocoa.

12. The package of claim 11, wherein the food container comprises an oxygen impermeable lid.

13. The package of claim 11, wherein the container and the filter are heat sealable.

14. The package of claim 2, wherein the carbon dioxide absorbent comprises calcium hydroxide or magnesium hydroxide.

15. The package of claim 12, wherein the oxygen scavenger contains calcium oxide or magnesium oxide powder and water in silica gel that react to produce calcium hydroxide.

16. The package of claim 1, wherein the container further comprises coffee in the filter and the filter is suspended above the bottom of the container.

17. The package of claim 1, wherein the container has a lid and the oxygen scavenger is attached to the lid of the container.

18. The package of claim 1, wherein the oxygen scavenger is attached to the walls of the container.

19. The package of claim 1, wherein the oxygen scavenger is contained in a polymer film or strip.

20. The package of claim 1, wherein the oxygen scavenger is formulated as a disc, tablet or capsule.

21. The package of claim 1, wherein the oxygen scavenger is in a sachet that is permeable to oxygen and impervious to liquid water.

22. The package of claim 1, wherein the mammal comprises a human.

23. An extended shelf life package comprising mammal ingestible material that degrades by giving off CO₂ comprising a carbon dioxide scavenger, a container substantially impervious to carbon dioxide, wherein the container has a filter suspended in the container, the filter holds the mammal ingestible material, and the container also holds the carbon dioxide scavenger.

24. The package of claim 23, wherein the carbon dioxide scavenger produces water when absorbing carbon dioxide.

25. The package of claim 23, wherein the human ingestible material is selected from the group consisting of coffee, tea, cocoa, and milk products.

26. The package of claim 23, wherein the material is coffee.

27. The package of claim 23, wherein the carbon dioxide scavenger comprises calcium hydroxide, silica gel, and water.

28. The package of claim 23, wherein the filter holds tea or cocoa.

29. The package of claim 28, wherein the container and the filter are heat sealable.

30. The package of claim 23, wherein the container further comprises coffee in the filter and the filter is suspended above the bottom of the container.

31. The package of claim 23, wherein the container has a lid and the carbon dioxide scavenger is attached to the lid of the container.

32. The package of claim 23, wherein the carbon dioxide scavenger is attached to the walls of the container.

33. The package of claim 23, wherein the carbon dioxide scavenger is contained in a polymer film or strip.

34. The package of claim 23, wherein the carbon dioxide scavenger is contained in or formulated as a disc, tablet, or capsule.

35. The package of claim 23, wherein the carbon dioxide scavenger is in a sachet that is permeable to carbon dioxide and impervious to liquid water.

36. The package of claim 23, wherein the mammal comprises a human.

37. A package comprising an impermeable bag containing at least one permeable containing a mammal ingestible material and containing oxygen scavengers or carbon dioxide scavengers.

38. The package of claim 37, wherein the at least one container comprises a closed container having a filter suspended in the container.

39. The package if claim 34 wherein the disc, tablet or capsule is coated with a polymer that is permeable to carbon dioxide.

40. The package if claim 20 wherein the disc, tablet or capsule is coated with a polymer that is permeable to oxygen.
